(19) United States
(12) Patent Application Publication
(10) Pub. No.: US 2020/0181781 A1
(43) Pub. Date: Jun. 11, 2020

(54) DEVICE FOR MANUFACTURING HYDROGEN WATER WITHOUT WATER STORAGE TANK

(71) Applicant: HUANTH CO., LTD., Gwangju-Si (KR)

(72) Inventor: Byoung Ho Ki, Seoul (KR)

(73) Assignee: HUANTH CO., LTD., Gwangju-Si (KR)

(21) Appl. No.: 16/662,132

(22) Filed: Oct. 24, 2019

(30) Foreign Application Priority Data
Dec. 11, 2018 (KR) 10-2018-0159430

(51) Int. Cl. C25B 1/10; C25B 9/10; C25B 15/08; C02F 1/28

(52) U.S. Cl. CPC C25B 1/10; C25B 9/10; C02F 2103/026; C02F 1/283; C25B 15/08

(57) ABSTRACT

Devices for manufacturing hydrogen water without a water storage tank include: a water supply line receiving raw water; an electrolysis part including an oxygen generating chamber and a hydrogen generating chamber individually receiving the raw water. Electrolysis is performed in the oxygen and hydrogen generating chambers. A dissolving part is provided to receive the generated hydrogen and the raw water discharged by a pump and increase a dissolution rate of the hydrogen. A water discharge line outputs the hydrogen water discharged from the dissolving part. The water discharge line includes a large diameter line to decrease a pressure of the hydrogen water output; and a small diameter line provided has an inner diameter less than an inner diameter of the large diameter line and connects an outlet of the dissolving part and an inlet of the large diameter line.

### CROSS-REFERENCE TO RELATED APPLICATION

This application claims priority to and the benefit of Korean Patent Application No. 10-2018-0159430, filed on Dec. 11, 2018, the disclosure of which is incorporated herein by reference in its entirety.

### BACKGROUND

### 1. Field of the Invention

The present invention relates to a device for manufacturing hydrogen water, and more specifically, to a device for manufacturing hydrogen water without a water storage tank which is capable of directly receiving external water without a water storage tank for storing water.

### 2. Discussion of Related Art

Hydrogen water is water in which a predetermined level or more of hydrogen is dissolved. The hydrogen water is known to neutralize and discharge reactive oxygen species accumulated in the human body so as to achieve effects of anti-aging, preventing various diseases (diabetes, hypertension, arteriosclerosis, cancer, dementia, and the like), skin care, fatigue recovery, strengthening immunity, and the like. As the effects of the hydrogen water are becoming known, devices for manufacturing hydrogen water are being developed and commercialized.

In Patent Registration No. 10-1562802 (System for Manufacturing Hydrogen Water) of the present applicant, a device for manufacturing hydrogen water with a water storage tank, which is one type of device for manufacturing hydrogen water, is disclosed. This device includes a water storage tank, and water supplied from the outside is maintained at a predetermined level and stored in the water storage tank. The water in the water storage tank is supplied to an electrolytic bath, and the water is electrolyzed in the electrolytic bath. Hydrogen generated through the electrolysis and the water move to a dissolving unit by a pump, and an amount of dissolved hydrogen is increased in the dissolving unit. Hydrogen water which passes through the dissolving unit is provided to a user.

A device for manufacturing hydrogen water with a water storage tank is also disclosed in Patent Registration Publication No. 10-1755309 (Simplicity Type Providing Apparatus for Hydrogen Water) or Patent Publication No. 10-2015-0145354 (Water Purifier Type Hydrogen Water Producing Apparatus)

Meanwhile, in order to relieve inconvenience in which a water storage tank should be included in a device for manufacturing hydrogen water with a water storage tank, a device for manufacturing hydrogen water which directly receives external water without a water storage tank, that is, a device for manufacturing hydrogen water without a water storage tank is disclosed in Patent Registration Publication No. 10-1741043 (Direct Type Providing Apparatus for Hydrogen Water).

In the device for manufacturing hydrogen water without a water storage tank, water directly supplied from the outside is electrolyzed while passing through an electrolytic bath and provided to a user when a solenoid valve is opened. In addition, in the device for manufacturing hydrogen water without a water storage tank, hydrogen water discharged from the electrolytic bath is returned to the electrolytic bath by a pump in a state in which the solenoid valve is closed in order to increase an amount of dissolved hydrogen.

### RELATED ART DOCUMENT

### Patent Document

(Patent Document 0001) Patent Registration Publication No. 10-1562802 (System for Manufacturing Hydrogen Water)

(Patent Document 0002) Patent Registration Publication No. 10-1755309 (Simplicity Type Providing Apparatus for Hydrogen Water)

(Patent Document 0003) Patent Publication No. 10-2015-0145354 (Water Purifier Type Hydrogen Water Producing Apparatus)

(Patent Document 0004) Patent Registration Publication No. 10-1741043 (Direct Type Providing Apparatus for Hydrogen Water)

### SUMMARY OF THE INVENTION

The most important technical task of a device for manufacturing hydrogen water is to increase an amount of dissolved hydrogen in hydrogen water supplied to a user regardless of a type thereof. Accordingly, in a device for manufacturing hydrogen water without a water storage tank disclosed in the Patent Registration Publication No. 10-1741043 (Direct Type Providing Apparatus for Hydrogen Water), hydrogen water discharged from an electrolytic bath is returned to the electrolytic bath so as to increase an amount of dissolved hydrogen. However, in this case, there are problems in that an additional power source is needed and a complex structure is also needed to return the hydrogen water.

Accordingly, the present invention is directed to providing a device for manufacturing hydrogen water without a water storage tank which is capable of increasing an amount of dissolved hydrogen only with a simple structure without an additional power source.

According to an aspect of the present invention, there is provided a device for manufacturing hydrogen water without a water storage tank including a water supply line which receives raw water from the outside; an electrolysis part including an oxygen generating chamber and an hydrogen generating chamber which individually receive the raw water through the water supply line, wherein electrolysis is performed when a voltage is applied to a pair of electrode plates provided in the oxygen generating chamber and the hydrogen generating chamber; a pump provided to pump hydrogen generated in the hydrogen generating chamber and the raw water in the hydrogen generating chamber to the outside of the hydrogen generating chamber when the electrolysis is performed; a dissolving part provided to receive the hydrogen and the raw water discharged by the pump and increase a dissolution rate of the hydrogen; and a water discharge line configured to output the hydrogen water discharged from the dissolving part. Here, the water discharge line includes a large diameter line configured to decrease a pressure of the hydrogen water which is output; and a small diameter line which is provided to have an inner diameter less than an inner diameter of the large diameter line and connects an outlet of the dissolving part and an inlet of the large diameter line.

A charcoal filter may be provided behind the dissolving part. In addition, the small diameter line may be provided to connect an outlet of the charcoal filter and the inlet of the large diameter line, and the outlet of the dissolving part and an inlet of the charcoal filter may be connected by a connecting line.

A water supply solenoid valve may be installed at the water supply line. The water supply solenoid valve may be controlled to be opened when the pump starts operation and closed when the pump stops the operation

A water discharge solenoid valve may be installed at the large diameter line. The water discharge solenoid valve may be controlled to be opened when operation of the pump starts and controlled to be closed when the operation of the pump stops.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a partially exploded perspective view illustrating a device for manufacturing hydrogen water without a water storage tank according to the present invention;

FIG. 2 is a perspective view illustrating an electrolysis part illustrated in FIG. 1; and

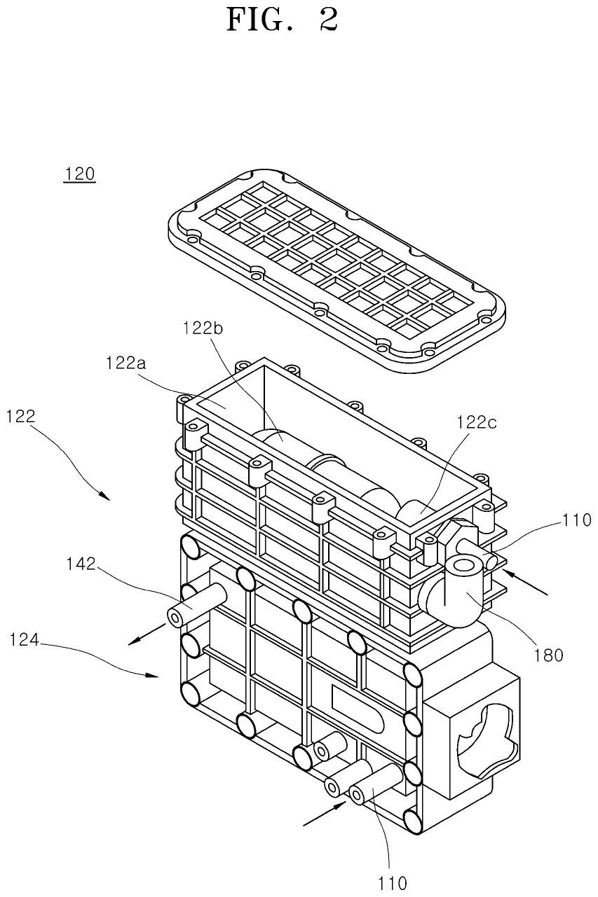

FIG. 3 is a cross-sectional view illustrating a state in which a dissolving part is connected to a charcoal filter connected to the dissolving part illustrated in FIG. 1.

### DETAILED DESCRIPTION OF EXEMPLARY EMBODIMENTS

Hereinafter, exemplary embodiments of a device for manufacturing hydrogen water without a water storage tank according to the present invention will be described in detail with reference to the accompanying drawings. Terms or words used in this specification are not to be interpreted as limited to commonly used meanings or meanings in dictionaries and should be interpreted as having meanings and concepts which are consistent with the technological scope of the invention based on the principle that the inventor has appropriately defined concepts of terms in order to describe the invention in the best way.

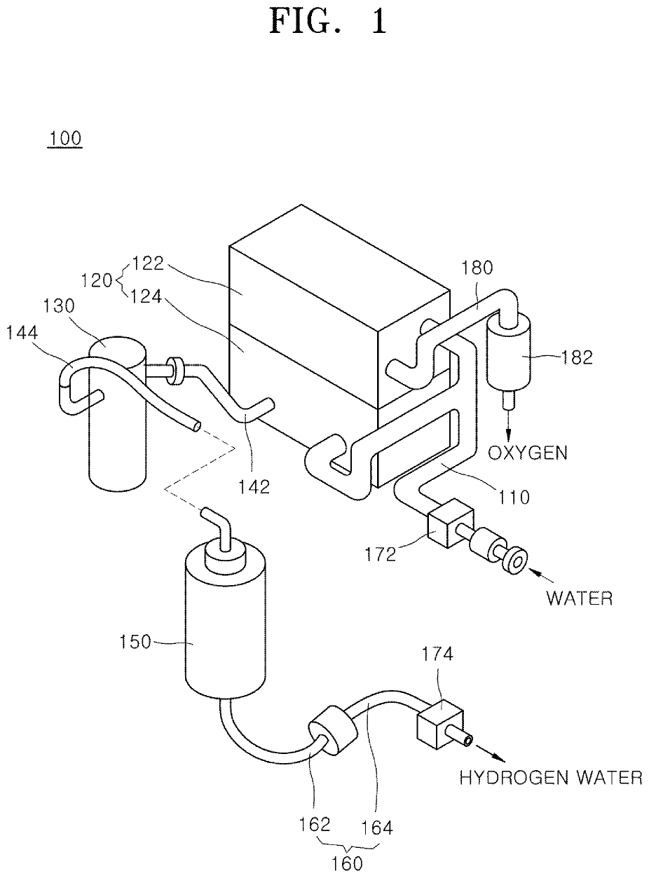

A device 100 for manufacturing hydrogen water without a water storage tank according to the present invention is a device for electrolyzing raw water directly received from the outside to generate hydrogen and providing hydrogen water in which the hydrogen is dissolved in the raw water with a high dissolution rate to a user, and the device 100 includes a water supply line 110, an electrolysis part 120, a pump 130, a dissolving part 150, and a water discharge line 160 as illustrated in FIG. 1.

The water supply line 110 is connected to an external raw water supply source (not shown), a hose, or the like to directly receive raw water from the raw water supply source. Here, the raw water supply source is a faucet (not shown) or a water purifier (not shown) which is connected to the faucet, purifies raw water supplied from the faucet, and outputs the water. In a case in which the raw water supply source is the faucet, a water purifying filter (not shown) may be provided at a frond end portion of the water supply line 110.

A water supply solenoid valve 172 is installed at the water supply line 110. In addition, the water supply line 110 is branched into two lines from behind the water supply solenoid valve 172, and two lines are connected to two portions of the electrolysis part 120.

The electrolysis part 120 is formed to have durability against high water pressure of the raw water supplied from the raw water supply source, and the electrolysis part 120 has been disclosed in Patent Registration No. 10-1711609 (Device for Manufacturing Hydrogen Water) of the present applicant. Accordingly, in the present invention, the electrolysis part 120, which is the same as that of Patent Registration No. 10-1711609, is formed. Accordingly, the present specification cites the contents described in Patent Registration No. 10-1711609 in the present specification. However, only contents which are needed to understand the present invention will be selected and described below.

The electrolysis part 120 includes a raw water storage chamber 122 and an electrolysis chamber 124 which are vertically stacked. Some raw water in the water supply line 110 is introduced into the raw water storage chamber 122 to be introduced into an oxygen generating chamber (not shown) in the electrolysis chamber 124. In addition, the remaining raw water in the water supply line 110 is introduced into a hydrogen generating chamber (not shown) inside the electrolysis chamber 124.

Since raw water in an interior 122a of the raw water storage chamber 122 is consumed in the oxygen generating chamber when electrolysis occurs in the electrolysis chamber 124, an amount of the raw water in the interior 122a is relatively less than that of the raw water introduced into the hydrogen generating chamber. In addition, a floating body 122b and a valve 122c are provided in the interior 122a of the raw water storage chamber 122 to maintain a predetermined water level of the raw water. When a water level in the interior 122a of the raw water storage chamber 122 rises and the floating body 122b rises, the valve 122c is closed and raw water cannot be supplied to the raw water storage chamber 122, and conversely, when the water level lowers and the floating body 122b lowers, the valve 122c is opened and raw water is supplied to the raw water storage chamber 122. The raw water in the interior 122a of the raw water storage chamber 122 is introduced into the oxygen generating chamber due to a weight thereof.

The electrolysis chamber 124 includes the oxygen generating chamber and the hydrogen generating chamber with an ion-exchange membrane disposed therebetween. The ion-exchange membrane is formed to block movement of raw water and to transmit cations. A positive electrode plate is positioned in the oxygen generating chamber, and a negative electrode plate is positioned in the hydrogen generating chamber. When a voltage is applied between the positive electrode plate and the negative electrode plate, electrolysis occurs, and in this case, hydrogen is generated in the hydrogen generating chamber and oxygen is generated in the oxygen generating chamber.

The pump 130 is positioned behind the electrolysis part 120. An inlet of the pump 130 is connected to the hydrogen generating chamber through a pump-in-line 142, and an outlet of the pump 130 is connected to the dissolving part 150 through a pump-out-line 144. Accordingly, when the pump 130 operates, hydrogen generated in the hydrogen generating chamber and raw water in the hydrogen generating chamber are pumped to the dissolving part 150.

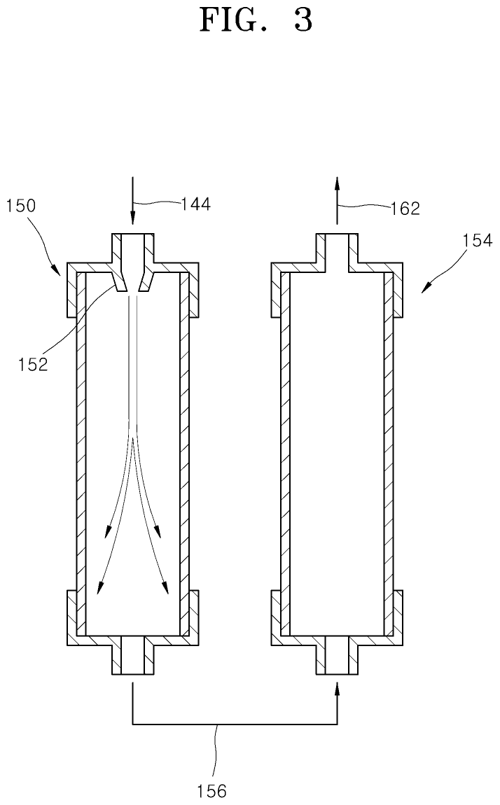

An inlet of the dissolving part 150 connected to the pump-out-line 144 is provided in an upper surface of the dissolving part 150, and an outlet of the dissolving part 150 is provided in a lower surface of the dissolving part 150. In addition, a nozzle 152 is provided in the upper surface of the dissolving part 150 as illustrated in FIG. 3.

When the hydrogen and the raw water are discharged from the hydrogen generating chamber as described above, an amount of hydrogen dissolved in the raw water is relatively small. However, when the nozzle 152 is provided in the dissolving part 150 as described above, since a pressure in the pump-out-line 144 is increased, an environment in which a gas solubility may be increased is formed in the pump-out-line 144, and thus a hydrogen dissolution rate increases while the hydrogen and the raw water are introduced into the dissolving part 150 through the pump-out-line 144.

In addition, since an inner diameter of the dissolving part 150 is greater than an inner diameter of the pump-out-line 144, raw water and hydrogen flows quickly in the pump-out-line 144 and flows relatively slowly in the dissolving part 150. Accordingly, a time period in which the raw water and the hydrogen remain in the dissolving part 150, that is, a time period in which hydrogen may be even more dissolved in the raw water may be secured, and thus a hydrogen dissolution rate can be increased in the dissolving part 150.

As described above, since the dissolving part 150 includes the nozzle 152, the dissolving part 150 serves a function to increase a hydrogen dissolution rate. A dissolving part which includes a nozzle for the same function as the dissolving part 150 but has a slightly different inner structure is disclosed in Patent Registration Publication No. 10-1562802 (System for Manufacturing Hydrogen Water) of the present applicant, which is introduced above in the related art. Since the dissolving part disclosed in Patent Registration Publication No. 10-1562802 may also be used as the dissolving part 150 according to the present invention, the contents about the dissolving part described in Patent Registration Publication No. 10-1562802 are also cited in this specification.

The water discharge line 160 is a line to output hydrogen water, and includes a large diameter line 164 on which a water discharge solenoid valve 174 is installed as illustrated in FIG. 1. Hydrogen water output from the large diameter line 164 is directly provided to the user, and in this case, when a pressure of the output hydrogen water is too high, since a problem occurs that the hydrogen water output from the large diameter line 164 splashes therearound, an inner diameter of the large diameter line 164 is set to be relatively large such that the pressure of the output water becomes low enough to prevent the hydrogen water from being splashes.

The water discharge line 160 also includes a small diameter line 162 as illustrated in FIG. 1. The small diameter line 162 is a line which connects the outlet of the dissolving part 150 and the large diameter line 164 and is provided to have an inner diameter which is less than the inner diameter of the large diameter line 164. The inner diameter of the small diameter line 162 is suitably selected in a range in which the inner diameter of the small diameter line 162 is less than the inner diameter of the large diameter line 164, and it is suitable for the inner diameter of the small diameter line 162 to be 62% of the inner diameter of the large diameter line 164 according to an experimental result of the present applicant.

When the small diameter line 162 is provided, since an environment is formed in which a gas solubility is increased in the small diameter line 162, hydrogen which is still not dissolved in hydrogen water in the dissolving part 150 may be additionally dissolved in the hydrogen water while the hydrogen and the hydrogen water pass through the small diameter line 162, and thus a hydrogen dissolution rate can be further increased. In addition, since the small diameter line 162 also serves a function of increasing an internal pressure of the dissolving part 150, the small diameter line 162 also has an advantage of increasing a hydrogen dissolution rate in the dissolving part 150. Accordingly, when the water discharge line 160 includes the small diameter line 162, a hydrogen dissolution rate in hydrogen water can be further increased when compared to a case in which the water discharge line 160 includes only the large diameter line 164.

In the device 100 for manufacturing hydrogen water without a water storage tank, since an environment in which a hydrogen dissolution rate may be increased is formed over all sections from the outlet of the pump 130 to an inlet of the large diameter line 164, the user may receive hydrogen water with a high hydrogen dissolution rate.

Meanwhile, the device 100 for manufacturing hydrogen water without a water storage tank may further include a charcoal filter 154 positioned behind the dissolving part 150 as illustrated in FIG. 3. Since a slightly odd smell may be generated in hydrogen water provided to the user due to ozone which may be generated in the electrolysis chamber 124, the charcoal filter 154 is positioned behind the dissolving part 150 so as to solve this problem.

In the charcoal filter 154, an inlet is provided in a lower surface, and an outlet is provided in an upper surface. In a case in which the charcoal filter 154 is added, the outlet of the dissolving part 150 and the inlet of the charcoal filter 154 are connected through a connecting line 156, and the small diameter line 162 is connected to the outlet of the charcoal filter 154.

Meanwhile, the water discharge solenoid valve 174 is controlled to operate in conjunction with operation of the pump 130. Specifically, at a time point at which operation of the pump 130 starts, the water discharge solenoid valve 174 is opened, and at a time point at which the operation of the pump 130 stops, the water discharge solenoid valve 174 is closed.

When the water discharge solenoid valve 174 operates in conjunction with the operation of the pump 130 as described above, first, while hydrogen water is output, the hydrogen water with a high hydrogen dissolution rate can be provided to the user because of an environment which is formed over all sections from the outlet of the pump 130 to the inlet of the large diameter line 164 and in which the hydrogen dissolution rate is increased, and second, while an output of the hydrogen water is stopped, high water pressure is maintained in a section between the pump 130 and the water discharge solenoid valve 174, and a decrease in hydrogen dissolution rate, which has been already achieved, can be minimized.

The water supply solenoid valve 172 is also controlled to operate in conjunction with the operation of the pump 130 like the water discharge solenoid valve 174. Specifically, at the time point at which the operation of the pump 130 starts, the water supply solenoid valve 172 is opened, and at the time point at which the operation of the pump 130 stops, the water supply solenoid valve 172 is closed.

In the device 100 for manufacturing hydrogen water without a water storage tank, raw water is continuously supplied from the raw water supply source such as the faucet, and in this case, when the raw water is continuously introduced into the electrolysis part 120 from the raw water supply source even when the operation of the pump 130 stops, a high water pressure is continuously applied to the hydrogen generating chamber of the electrolysis part 120, and then, damage or failure of the electrolysis part 120 may easily occur. Accordingly, in the present invention, at the time point at which the pump 130 stops the operation, the water supply solenoid valve 172 is closed to block the raw water from being introduced into the electrolysis part 120.

The pump 130 and the solenoid valves 172 and 174 are controlled using a controller (not shown) such as a printed circuit board (PCB). The controller also controls a power source (not shown) connected to a pair of electrode plates (not shown) provided in an electrolysis chamber (not shown), applies a voltage to the pair of electrode plates at the time point at which the operation of the pump 130 starts, and stops the voltage so as to not apply the voltage thereto at the time point at which the operation of the pump 130 stops.

Meanwhile, oxygen generated in the oxygen generating chamber when electrolysis is performed moves upward to the raw water storage chamber 122 and is accumulated in a space above a water surface of raw water in the raw water storage chamber 122. In the present invention, an oxygen exhaust line 180 is provided so as to exhaust the oxygen accumulated as described above to the outside from the raw water storage chamber 122. The oxygen exhaust line 180 is installed in the raw water storage chamber 122 such that the space above the water surface of the raw water in the raw water storage chamber 122 communicates with an outer space from the raw water storage chamber 122. In addition, a charcoal filter 182 may be installed in the oxygen exhaust line 180 so as to remove an odd smell caused by ozone which may be generated with the oxygen when the electrolysis is performed.

According to the present invention, an environment in which a hydrogen dissolution rate may be increased without an additional power source is formed simply over all sections from an outlet of a pump to an inlet of a large diameter line.

Further, according to the present invention, there is no possibility for an odd smell to be generated due to ozone in hydrogen water provided to a user.

Furthermore, according to the present invention, since raw water is blocked from being introduced into an electrolysis part at a time point at which operation of the pump stops, damage or failure of the electrolysis part caused by continuously applying high water pressure thereon is prevented.

In addition, according to the present invention, since high water pressure is maintained in a section between the pump and a water discharge solenoid valve even while an output of the hydrogen water stops, a decrease in high hydrogen dissolution rate which is already achieved is minimized.

As described above, although the present invention has been described with reference to the limited specific embodiments and drawings, various modifications and changes may be made by those skilled in the art in the technical concept of the present disclosure, the scope which will be defined in the claims below, and their equivalents, and the above-described embodiments may be variously combined.

What is claimed is:

1. A device for manufacturing hydrogen water without a water storage tank, comprising:
a water supply line which directly receives raw water from the outside, includes a water supply solenoid valve, and is branched into two lines from behind the water supply solenoid valve, and in which all sections of the two lines are formed of only pipes;
an electrolysis part including a hydrogen generating chamber directly connected to any one of the two lines of the water supply line, a raw water storage chamber directly connected to the remaining one thereof, and an oxygen generating chamber separated from the hydrogen generating chamber by an ion-exchange membrane and provided to receive the raw water from the raw water storage chamber, wherein electrolysis is performed when a voltage is applied to a pair of electrode plates provided in the oxygen generating chamber and the hydrogen generating chamber;
when the electrolysis is performed, a pump provided to pump hydrogen generated in the hydrogen generating chamber and the raw water in the hydrogen generating chamber to an outside of the hydrogen generating chamber;
a dissolving part provided to receive the hydrogen and the raw water discharged by the pump and increase a dissolution rate of the hydrogen; and
a water discharge line which outputs hydrogen water discharged from the dissolving part,
wherein the water discharge line includes a large diameter line configured to decrease a pressure of the hydrogen water and output the hydrogen water and a small diameter line which includes only a pipe having an inner diameter which is less than an inner diameter of the large diameter line and connects an outlet of the dissolving part and an inlet of the large diameter line, and
the water supply solenoid valve is controlled to be opened when operation of the pump starts and controlled to be closed when the operation of the pump stops.

2. The device of claim 1, wherein:
a charcoal filter is provided behind the dissolving part;
the small diameter line is provided to connect an outlet of the charcoal filter and the inlet of the large diameter line; and
the outlet of the dissolving part and an inlet of the charcoal filter are connected by a connecting line.

3. The device of claim 1, wherein:
a water discharge solenoid valve is installed at the large diameter line; and
the water discharge solenoid valve is controlled to be opened when operation of the pump starts operation and controlled to be closed when the operation of the pump stops.
